(19) United States
(12) Patent Application Publication
(10) Pub. No.: US 2014/0206311 A1
(43) Pub. Date: Jul. 24, 2014

(54) METHODS AND APPARATUS FOR PROVIDING PRE-PAID PAYMENT CAPABILITY ON MOBILE TELEPHONE

(71) Applicant: MasterCard International Incorporated, Purchas, NY (US)

(72) Inventors: Ronald D. Carter, Barrington (GB); Simon Phillips, York (GB); David A. Roberts, Warrington (GB); Patrick Mestré, Namur (BE); Jean Somers, Grivegnee (BE); Paul Vanneste, Ottignies (BE)

(73) Assignee: MasterCard International Incorporated, Purchas, NY (US)

(21) Appl. No.: 14/221,871

(22) Filed: Mar. 21, 2014

Related U.S. Application Data
(63) Continuation of application No. 12/481,703, filed on Jun. 10, 2009.

(51) Int. Cl. H04M 17/00; H04W 4/24

(52) U.S. Cl. CPC H04M 17/301; H04W 4/24
USPC 455/408

(57) ABSTRACT

A method includes a processor of a mobile telephone receiving a top-up request for an offline balance in an offline payment application of the mobile telephone, and opening an over-the-air (OTA) connection to a top-up authorization server computer. The user is prompted to enter a monetary amount for the offline balance and to enter a form of authentication. The method also includes receiving a monetary amount input and a user authentication input, authenticating the user, calculating a cryptogram and transmitting an OTA top-up request message to the top-up authorization server computer. In addition, the method includes receiving an OTA response indicating authorization of the top-up request and including a script. The processor then executes the script to increase the offline balance stored in the mobile telephone by the monetary amount.

### CROSS-REFERENCE TO RELATED APPLICATION

This application is a continuation application of U.S. patent application Ser. No. 12/481,703 filed on Jun. 10, 2009, which application is incorporated herein in its entirety by reference.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

More recently, cards that incorporate an integrated circuit (IC) have been utilized as payment cards. One well known IC payment card standard is referred to as “EMV”, and utilizes an IC card (also known as a “smart card”) that is interfaced to a POS terminal via contacts on the IC card. During a purchase transaction, the payment card account number and other information may be uploaded from the IC payment card to the POS terminal via the IC card contacts and a contact card reader that is included in the POS terminal.

In other IC payment card systems, the exchange of information between the card and the POS terminal proceeds via wireless RF (radio frequency) communications.

These wireless communication payment cards are sometimes referred to as “contactless” payment cards. One example of a contactless payment card standard is referred to in the United States by the brand name “PayPass” and was established by MasterCard International Incorporated, the assignee hereof. It has also been proposed to use wireless exchanges of information via NFC (Near Field Communication) for payment applications.

It has been proposed that the capabilities of a contactless payment card be incorporated into a mobile telephone, thereby turning the mobile telephone into a contactless payment device. Typically a mobile telephone/contactless payment device includes integrated circuitry with the same functionality as the RFID (radio frequency identification) IC of a contactless payment card. In addition, the mobile telephone/contactless payment device includes a loop antenna that is coupled to the payment-related IC for use in sending and/or receiving messages in connection with a transaction that involves contactless payment.

In addition to debit and credit IC payment cards, there are also so-called “prepaid” cards. These cards are not linked to a credit card account or to a bank account from which debits are made via the payment card system. Rather, prepaid cards are loaded (“topped-up”) from time to time with monetary value, and the cards are used to make purchases based on deductions from the value stored in the cards. One advantage of such cards is that the POS terminal does not need to engage in an online transaction to obtain authorization of the pending purchase by way of the payment card system.

According to another type of payment system, payment cards or other payment devices that are linked to a credit or debit account may be “pre-authorized” for at least some transactions. For example, according to some practices, an IC payment card may be accepted for “off-line” transactions, say below a certain monetary limit. For off-line transactions, typically the user may be required to provide a PIN (personal identification number) as a form of authentication, but with no requirement for online communication via the payment card system to obtain authorization for the transaction from the issuer of the payment device. The payment device uploads the payment account number to the

POS terminal as part of the transaction, and the transaction is later cleared against the credit or debit account via the merchant's acquirer and the account/payment device issuer.

When it is necessary to top-up a prepaid card, the card may be interfaced to a terminal or kiosk (by a contact interface or via short-range—contactless—wireless RF communication). The user may interact with the terminal to obtain authorization from a central server to have more monetary value loaded into the prepaid card.

To date, the functionality of a prepaid card has not been incorporated in a mobile telephone.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a system provided in accordance with the present invention.

FIG. 2 is a block diagram that illustrates an embodiment of a “back office” server computer that is part of the system of FIG. 1.

FIG. 3 is a block diagram that illustrates an embodiment of a “top-up” server computer that is part of the system of FIG. 1 and that may be provided in accordance with aspects of the present invention.

FIG. 4 is a block diagram that illustrates a mobile telephone that is used in connection with the system of FIG. 1 and that is provided in accordance with aspects of the present invention.

FIG. 5 is a block diagram that illustrates some details of the mobile telephone of FIG. 4.

FIG. 6 is a diagram that illustrates aspects of program instructions stored in the mobile telephone of FIG. 4.

FIG. 7 is a flow chart that illustrates a process that may be performed in the top up server of FIG. 3 in accordance with aspects of the present invention.

FIG. 8 is a flow chart that illustrates a process that may be performed in the mobile telephone of FIG. 4 in accordance with aspects of the present invention.

### DETAILED DESCRIPTION

In general, and for the purpose of introducing concepts of embodiments of the present invention, a mobile telephone includes a payment application. The payment application, possibly in conjunction with other software in the mobile telephone, transmits an over-the-air (hereinafter “OTA”) message to a server computer, requesting topping-up of a prepaid balance stored in the mobile telephone. The server computer verifies and authorizes the request, meanwhile arranging for a charge to be made to the user's underlying payment card account. In addition, the server computer transmits an OTA response to the mobile telephone. The response contains a script. The payment application in the mobile telephone executes the script, and execution of the script causes the prepaid balance stored in the mobile telephone to be increased. For example, the execution of the script increases a cumulative monetary limit of offline transactions entered into, or to be entered into, by the mobile telephone.

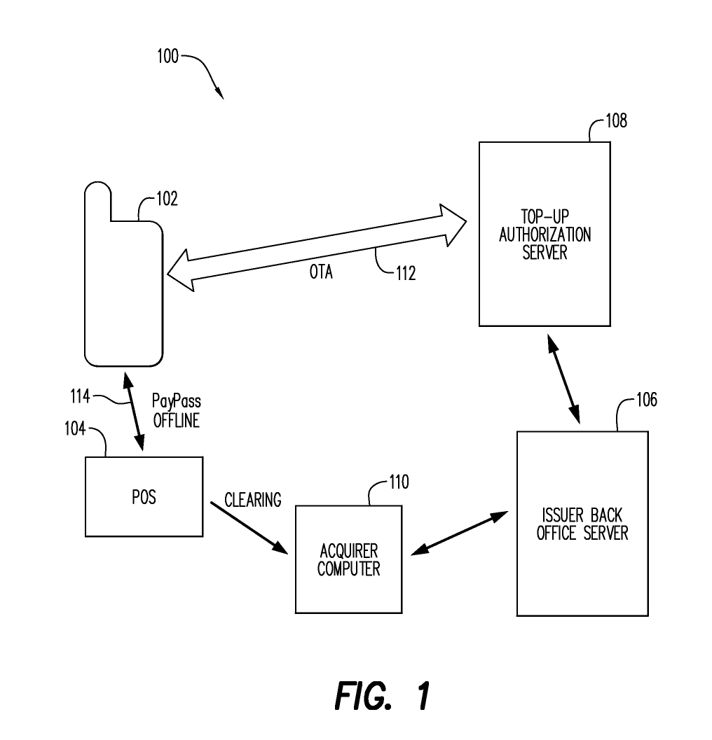

FIG. 1 is a block diagram that illustrates a system 100 in which the present invention may be applied.

The system 100 includes a mobile telephone 102, which includes prepaid payment capabilities, as will be seen. That is, the mobile telephone 102 is operable to engage in offline purchase transactions at point of sale (POS) terminals, including a POS terminal 104 shown in FIG. 1.

For purposes of illustration, only one mobile telephone and only one POS terminal are shown in FIG. 1. However, in practice, the system 100 may encompass numerous mobile telephones (belonging to numerous users) with prepaid payment capabilities, and may also include numerous POS terminals capable of handling offline purchase transactions by deducting stored value from such mobile telephones. (In addition, at least some of the POS terminals may also be operative to handle offline purchase transactions with conventional prepaid cards, as well as, possibly, conventional online purchase transactions with contact, contactless, and/or magnetic stripe payment cards.)

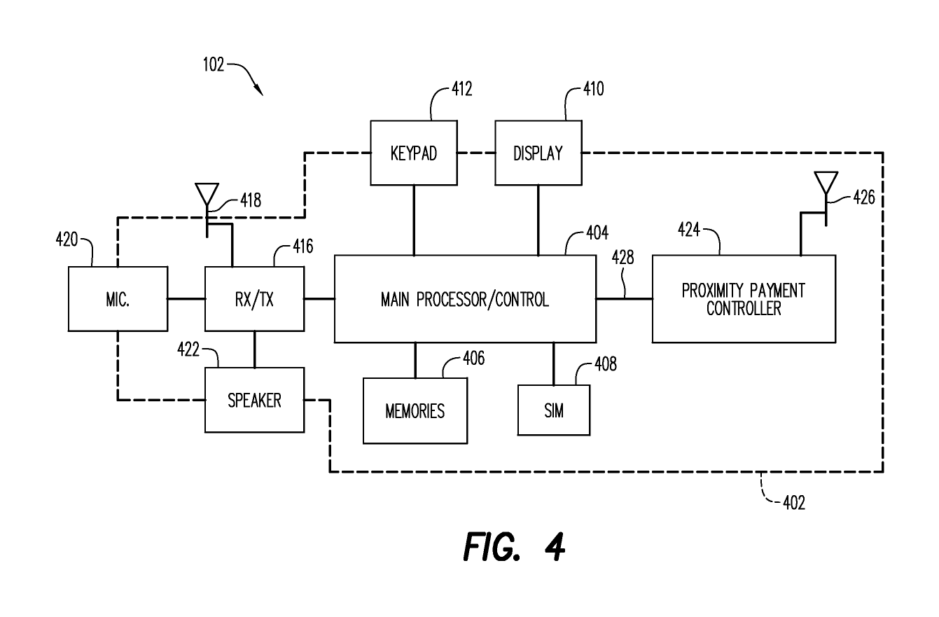

Details of the mobile telephone 102 will be described below in conjunction with FIGS. 4-6. The POS terminal 104 may operate in an essentially conventional manner.

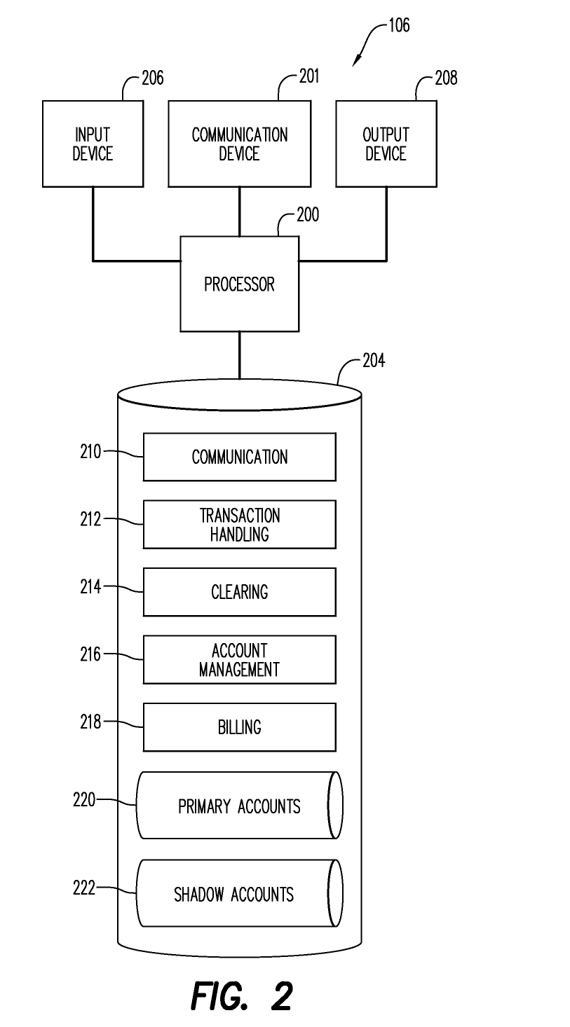

The system 100 also includes an issuer back-office server computer 106. Details of the issuer back-office computer are provided below in conjunction with FIG. 2. However, to briefly anticipate later discussion, the issuer back-office server computer 106 may be operated by or on behalf of the financial institution (not separately shown) which issued a payment card account to the user of the mobile telephone 102. The issuer back-office server computer 106 handles and maintains records of payment and top-up transactions engaged in by the mobile telephone 102, and generally manages the user's activities in connection with his/her payment card account.

Again, although only one issuer back-office server computer is shown in the drawing, in practice numerous issuers may participate in the system 100, and accordingly there may be a considerable number of issuer back-office server computers included in the system. However, for a given user, all of his/her transactions will result in activity by the particular issuer back-office server computer operated by the issuer of his/her payment card account.

It should also be noted that the functions attributed in this document to the issuer back-office server computer 106 may in some embodiments be distributed among two or more computers operating in conjunction with each other.

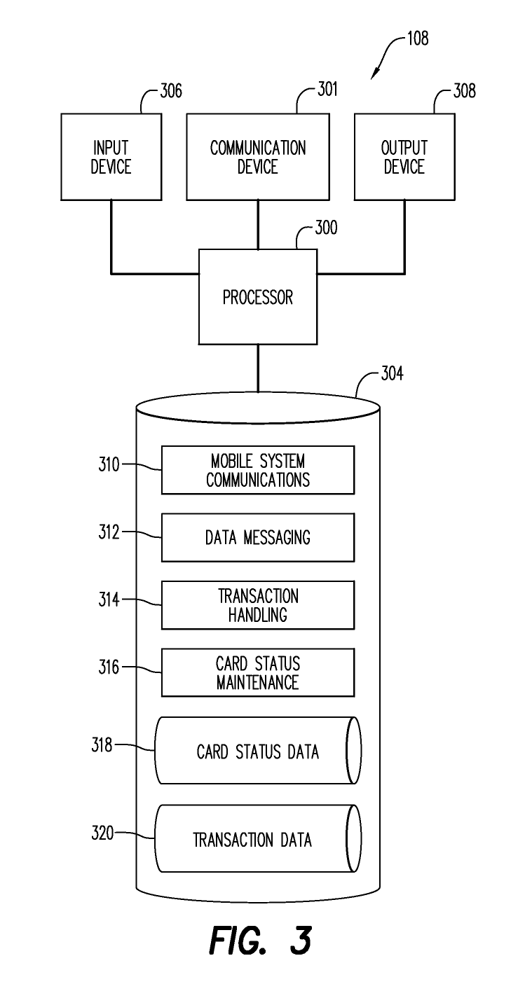

Also included in the system 100 is a top-up authorization server computer 108. Details of the top-up authorization server computer 108 will be provided below in conjunction with FIG. 3. Again to briefly anticipate later discussion, the top-up authorization server computer 108 handles OTA top-up requests from mobile telephones, interacts with the issuer back-office server computer 106 to arrange for charging of the users' accounts, and issues OTA responses to the mobile telephones to implement top-ups for the prepaid balances in the mobile telephones.

In some embodiments of the system 108, there may be only one top-up authorization server computer, which handles all top-up requests for the system.

However, in other embodiments, each issuer (and/or two or more groups of issuers) may set up its own top-up authorization server computer to handle top-up requests for the users served by the issuer or issuers in question.

An acquirer computer 110 is also shown in FIG. 1 as being part of the system 100. The acquirer computer 110 may operate in a conventional fashion to receive from point of sale terminals (or merchant/transaction processor computers coupled to POS terminals) data representing offline transactions handled by the POS terminals. The acquirer computer 110 handles clearing for the offline transactions such that the amounts due to the merchants which operate the POS terminals are transferred from the issuers to the merchants. The acquirer computer 110 may be operated by the financial institution with which the merchant does its banking In practice, the acquirer computer 110 may also handle conventional online transactions that involve credit or debit cards.

There may be many financial institutions that participate in the system 100 as acquirers. Consequently, the system 100 may include many more acquirer computers than the single acquirer computer that is shown in the drawing.

Before describing some of the components of the system in more detail, an overview of operation of the system 100 will now be provided.

In order for the mobile telephone 102 to engage in an offline purchase transaction, the mobile telephone must first be loaded with a prepaid balance. This is done via a top-up transaction in which the mobile telephone 102 and the top-up authorization server 108 exchange OTA messages, as indicated at 112 in FIG. 1. The top-up authorization server computer 108 communicates with the issuer back-office server computer 106 to determine whether the user's payment card account is in order, and if so, the issuer back-office server computer 106 causes the amount of the top-up to be charged to the user's payment card account. That amount, in turn, is transferred to a “shadow account” in the issuer back-office server computer 106 to be used for clearing offline transactions from the user's mobile telephone 102.

Upon receiving an indication from the issuer back-office server computer 106 that the top-up may proceed, the top-up authorization server computer 108 sends a response message to the mobile telephone 102, causing the mobile telephone 102 to increase the prepaid balance stored in the mobile telephone 102.

Thereafter, the user of the mobile telephone visits a merchant and uses the mobile telephone to conduct an offline purchase transaction at the merchant's POS terminal 104. The offline transaction may be performed via a proximity reader (not separately shown) that is associated with the POS terminal 104 and may involve a short-distance wireless exchange of messages between the proximity reader and the mobile telephone 102. By way of example, this exchange of messages may be conducted in accordance with the EMV or PayPass protocols for offline transactions, as indicated at 114 in the drawing. The POS terminal then communicates—directly or indirectly—with the acquirer computer 110 to arrange for clearing of the transaction with the issuer back-office server computer 106 from the above-mentioned shadow account for the user, to result in crediting of the transaction amount to the merchant. In the clearing process, communication between the acquirer computer 110 and the issuer back-office server computer 106 may be carried out via a conventional payment system (not shown) such as that operated by the assignee hereof.

FIG. 2 is a block diagram that illustrates an embodiment of the issuer back-office server computer 106.

The issuer back-office server computer 106 may be conventional in its hardware aspects but may be controlled by software to cause it to function as described herein. For example, the issuer back-office server computer 106 may be constituted by conventional server computer hardware.

The issuer back-office server computer 106 may include a computer processor 200 operatively coupled to a communication device 201, a storage device 204, an input device 206 and an output device 208.

The computer processor 200 may be constituted by one or more conventional processors. Processor 200 operates to execute processor-executable steps, contained in program instructions described below, so as to control the issuer back-office server computer 106 to provide desired functionality.

Communication device 201 may be used to facilitate communication with, for example, other devices (such as the top-up authorization server computer 108 shown in FIG. 1). For example, communication device 201 may comprise numerous communication ports (not separately shown), to allow the issuer back-office server computer 106 to communicate simultaneously with a number of other computers, including for example computers that implement a payment system by which offline merchant transactions are cleared, and/or which handles conventional online payment card transactions.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of issuer back-office server computer 106, executed by the processor 200 to cause the issuer back-office server computer 106 to function as described herein.

The programs may include a communication application 210 that controls the processor 200 to enable the issuer back-office server computer 106 to engage in data communication with other computers in a conventional manner. The programs may also include a transaction handling application 212 that controls the processor 200 to enable the issuer back-office server computer 106 to handle payment card account transactions in a conventional manner. Among these transactions may be charges to users' payment card accounts in regard to top-up transactions implemented by the top-up authorization server computer 108 in cooperation with the issuer back-office server computer 106. The transaction handling application 212 may also handle conventional payment card system purchase transactions.

Another program that may be stored on the storage device 204 is a transaction clearing application 214. The clearing application 214 may enable the issuer back-office server computer 106 to respond to clearing requests originating from acquirer computers (e.g., via a payment system which is not shown) to clear offline transactions engaged in by the issuer's customers. The clearing application 214 may function to clear the offline transactions against the users' shadow accounts.

The programs stored on the storage device 204 may further include an account management application 216. The application may manage users' payment card and shadow accounts, including opening and closing of accounts, and overseeing whether the accounts are maintained in good standing (e.g., by users' timely payment of amounts due).

Still further, the programs stored on the storage device 204 may include a billing application 218. The billing application 218 may handle generation of bills to users and may track whether payments are received as required.

The storage device 204 may also store data required for operation of the issuer back-office server computer 106, including data 220 regarding users' payment card account balances and transactions, and data 222 relating to users' shadow accounts that are used to clear offline transactions.

FIG. 3 is a block diagram that illustrates an embodiment of the top-up authorization server computer 108.

The top-up authorization server computer 108 may be conventional in its hardware aspects but may be controlled by software to cause it to function as described herein and in accordance with aspects of the present invention. For example, the top-up authorization server computer 108 may be constituted by conventional server computer hardware.

The top-up authorization server computer 108 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the top-up authorization server computer 108 to provide desired functionality.

Communication device 301 may be used to facilitate communication with, for example, other devices (such as the issuer back-office server computer 106 shown in FIG. 1). For example, communication device 301 may include one or more interfaces (not separately shown) by which the top-up authorization server computer 108 may engage in OTA communications with users' mobile telephones. For example, communication device 301 may comprise numerous communication ports (not separately shown).

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of top-up authorization server computer 108, executed by the processor 300 to cause the top-up authorization server computer 108 to function as described herein and in accordance with aspects of the present invention.

The programs may include an application 310 that controls the processor 300 to enable the top-up authorization server computer 108 to engage in OTA communications with users' mobile telephones. For example, the application 310 may enable the top-up authorization server computer 108 to engage in data communication with mobile telephones via GPRS (General Packet Radio Service). The communications between the mobile telephones and the top-up authorization server computer 108 may be in the nature of webpage access sessions.

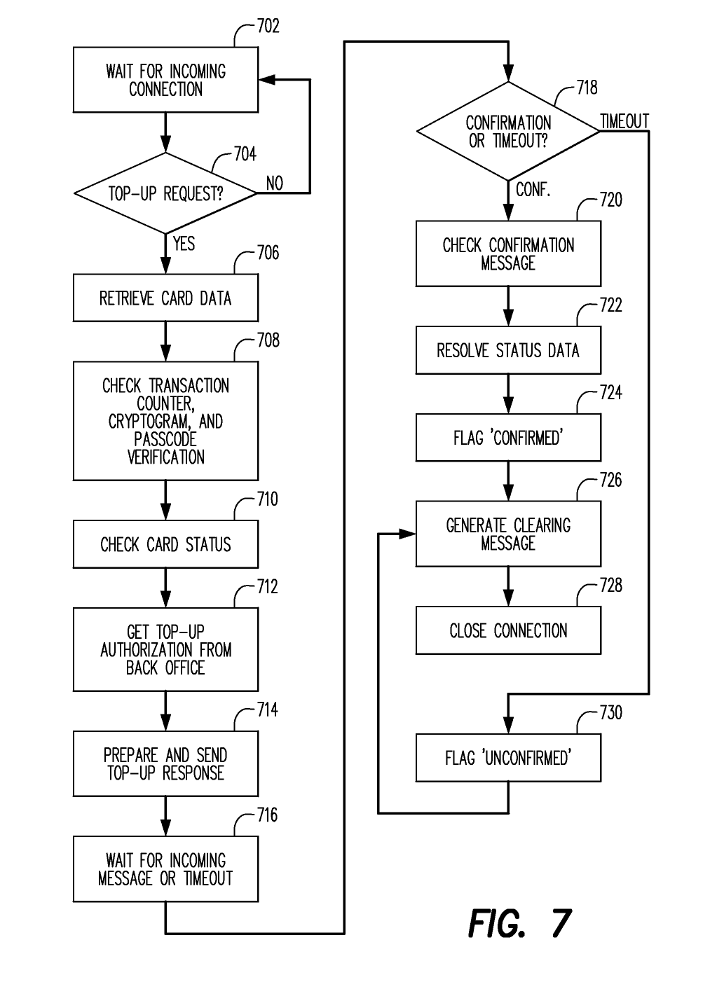

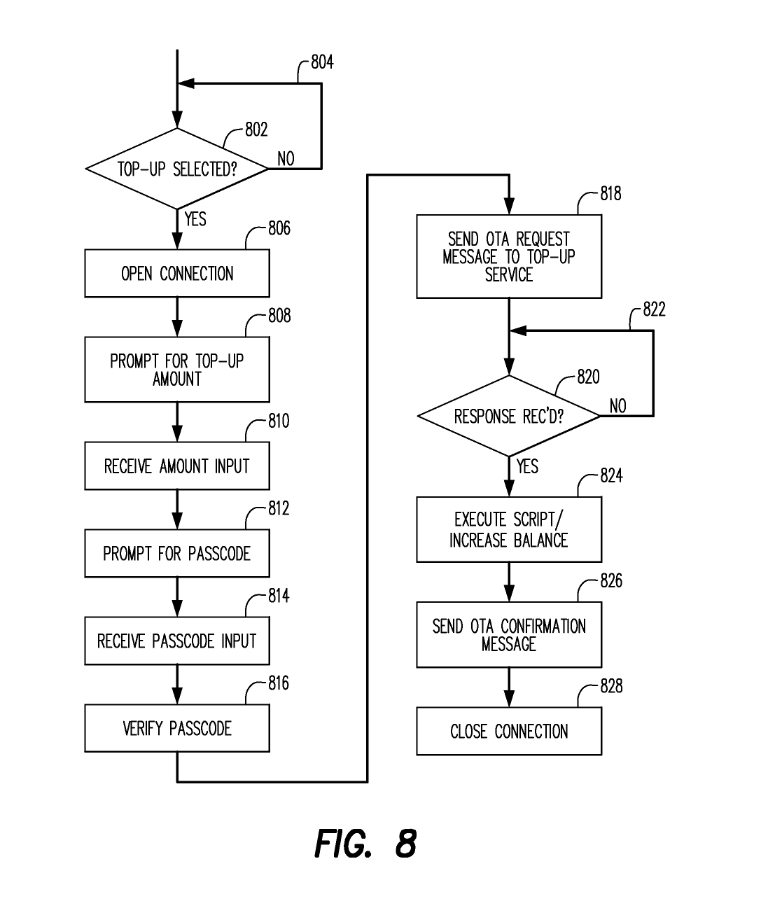

The programs stored in the storage device 304 may also include conventional data communication software 312 with which the top-up authorization server computer 108 may exchange data messages with other computers, such as the issuer back-office server computer 106. The programs may also include a transaction handling application 314 that controls the processor 300 to enable the top-up authorization server computer 108 to handle top-up transactions, as described in more detail below in connection with FIG. 7.

Another program that may be stored on the storage device 304 is an application 316 that controls processor 300 such that the top-up authorization server computer 108 maintains a database (reference numeral 318; also stored on the storage device 304) relating to the status of users' card accounts. For example, the card status information may indicate balance parameters for the users' accounts, and one or more flags that aid the top-up authorization server computer 108 in determining whether the latest top-up transaction was confirmed as having been successfully completed. The card status information may also include a transaction counter value. The card status information may, for example, be indexed by the user's primary account number (PAN).

The storage device 204 may also store a database 320 which stores information regarding the top-up transactions handled by the top-up authorization server computer 108.

FIG. 4 is a block diagram representation of the mobile telephone 102, as provided in accordance with aspects of the present invention. The mobile telephone 102 may be conventional in its hardware aspects.

The mobile telephone 102 may include a conventional housing (indicated by dashed line 402 in FIG. 4) that contains and/or supports the other components of the mobile telephone 102. The housing 402 may be shaped and sized to be held in a user's hand, and may for example fit in the palm of the user's hand.

The mobile telephone 102 further includes conventional control circuitry 404, for controlling over-all operation of the mobile telephone 102. Other components of the mobile telephone 102, which are in communication with and/or controlled by the control circuitry 404, include: (a) one or more memory devices 406 (e.g., program and working memory, etc.); (b) a conventional SIM (subscriber identification module) card 408; (c) a keypad 412 for receiving user input; and (d) a conventional display component 410 for displaying output information to the user. For present purposes the keypad 412 will be understood to include, e.g., a conventional 12-key telephone keypad, in addition to other buttons, switches and keys, such as a conventional rocker-switch/select key combination, soft keys, and send and end keys.

The mobile telephone 102 also includes conventional receive/transmit circuitry 416 that is also in communication with and/or controlled by the control circuitry 404. The receive/transmit circuitry 416 is coupled to an antenna 418 and provides the communication channel(s) by which the mobile telephone 102 communicates via the mobile telephone communication network (not shown). The receive/transmit circuitry 416 may operate both to receive and transmit voice signals, in addition to performing data communication functions, such as GPRS communications.

The mobile telephone 102 further includes a conventional microphone 420, coupled to the receive/transmit circuitry 416. Of course, the microphone 420 is for receiving voice input from the user. In addition, a loudspeaker 422 is included to provide sound output to the user, and is coupled to the receive/transmit circuitry 416.

In conventional fashion, the receive/transmit circuitry 416 operates to transmit, via the antenna 418, voice signals generated by the microphone 420, and operates to reproduce, via the loudspeaker 422, voice signals received via the antenna 418. The receive/transmit circuitry 416 may also handle transmission and reception of text messages and other data communications via the antenna 418.

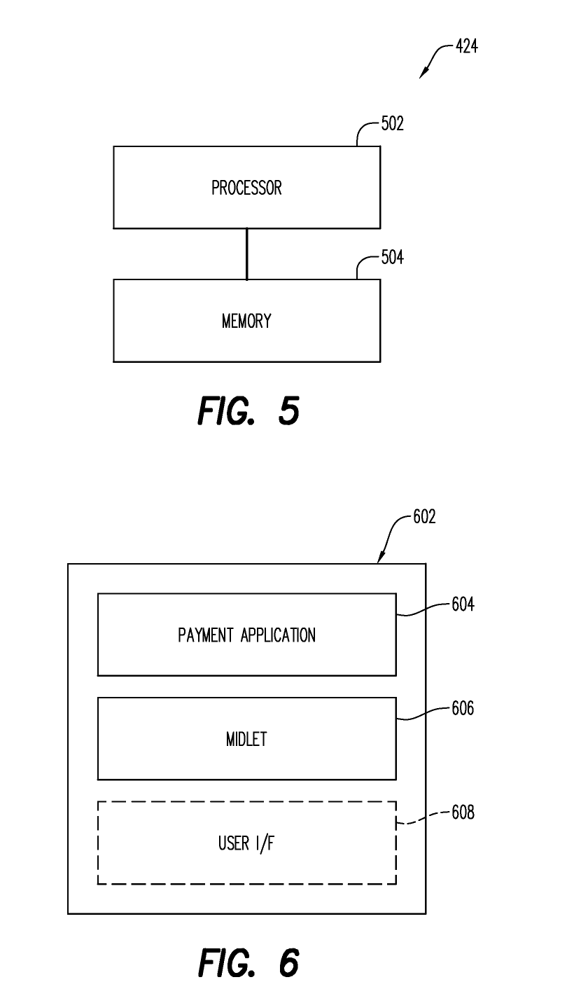

The mobile telephone 102 may also include a payment circuit 424 and a loop antenna 426, coupled to the payment circuit 424. The payment circuit 424 may include functionality that allows the mobile telephone 102 to serve as a contactless offline (prepaid) payment device. Details of the payment circuit 424 are shown in block diagram form in FIG. 5.

Referring then to FIG. 5, the payment circuit 424 includes a processor 502. Although shown as separate from the main processor 404 (FIG. 4), the processor 502 may be integrated with the main processor. If separate from the main processor 404, the processor 502 may be in communication therewith (as suggested by connection 428 shown in FIG. 4). In addition or alternatively, the processor 502 may be at least partially provided on the SIM card 408.

Continuing to refer to FIG. 5, the payment circuit 424 further includes a memory 504 that is in communication with the control circuit 502. The memory 504 may be constituted by one or more different devices that store data and/or program instructions, and may overlap at least partially with the memories 406 shown in FIG. 4. (Alternatively, the memory 504 may be separate from the memories 406 shown in FIG. 4.) The memory 504 may store program instructions (which may also be referred to as computer readable program code means) that control the operation of the processor 502 to provide functionality as described herein. The memory 504 may also be referred to as a computer readable medium.

FIG. 6 schematically illustrates aspects of at least some of the program instructions (generally indicated by reference numeral 602) stored in the memory 504 shown in FIG. 5. For example, the program instructions 602 may include a payment application 604. The payment application 604 may operate in a substantially conventional manner to implement some aspects of offline payment functionality in the mobile telephone 102. For example, in some embodiments, the payment application 604 may be, or may be similar to, the M/Chip 4 Select program that has been made publicly available by the assignee hereof. In some embodiments, a major function of the payment application 604 may be to store the available balance for offline purchase transactions. In some embodiments, the available balance may be effectively stored in terms of two amounts, namely an upper cumulative transaction amount, and an actual cumulative transaction amount, with the available balance being the difference between the two amounts. Consequently, in these embodiments, topping-up may be executed by increasing the upper cumulative transaction amount.

The program instructions 602 include a “midlet” 606. The midlet 606 is an application program that may operate as “middleware” to manage interactions among the payment application 604, the user and the top-up authorization server computer 108. In other words, the midlet 606 may provide a software interface among the payment application 604, user interface software 608 (shown in phantom in FIG. 6; in practice the user interface software may be stored in the one or more of the main memories 406, FIG. 4), and the top-up authorization server computer 108. Details of operation of the midlet 606 will be described below in connection with FIG. 8.

In some embodiments a “personalization” process may be performed with respect to the mobile telephone 102 to enable it to perform as a prepaid payment device. The personalization process may include loading the payment application, the midlet, and card- and/or user-specific data (e.g., PAN, user name) into one or more memories in the mobile telephone 102. The personalization process may generally be performed in a conventional manner. An example personalization process is described in commonly-assigned U.S. patent application Ser. No. 11/958,695, filed Dec. 18, 2007.

FIG. 7 is a flow chart that illustrates a process that may be performed in the top-up authorization server computer 108 in accordance with aspects of the present invention.

At 702 in FIG. 7, the top-up authorization server computer 108 waits until an incoming connection occurs. That is, the top-up authorization server computer 108 awaits receiving an OTA communication from a user's mobile telephone (represented by the mobile telephone 102 in FIG. 1). Continuing to refer to FIG. 7, at 704 the top-up authorization server computer 108 determines whether it has received a request (in the form of an OTA message) for a top-up transaction from the mobile telephone 102 via the OTA connection. If not, the process of FIG. 7 may loop back to 702. However, if it is determined at 704 that a top-up request has been received, then the process of FIG. 7 advances from 704 to 706.

At 706, the top-up authorization server computer 108 retrieves from database 318 (FIG. 3) data related to the user's card account number, as contained in the top-up request. The retrieved data may include status information to aid the top-up authorization server computer 108 in determining whether the most recent previous top-up transaction was confirmed as having been successfully completed. In addition, the retrieved data may include information relating to the most recent known and/or pending available balance for the mobile telephone 102. For example, the balance information may be a cumulative upper limit to offline transactions that was previously loaded or attempted to be loaded into the mobile telephone 102.

The process of FIG. 7 advances from 706 to 708. At 708 the top-up authorization server computer 108 performs checks with respect to information contained in the top-up request received from the mobile telephone 102. For example, the top-up request may include a cryptogram, and the top-up authorization server computer 108 may perform a cryptographic calculation to produce a result that should match the received cryptogram, if the received cryptogram is valid. The top-up request may also include an indication as to whether the user properly entered a passcode in the process of generating the top-up request with the mobile telephone, and the top-up authorization server computer 108 may check to see that the indication has the proper value. Further, the top-up request may include a transaction counter value, and the top-up authorization server computer 108 may determine whether the transaction counter value in the top-up request matches the expected value indicated by the card data received at 706.

Following step 708 is step 710. At 710, the top-up authorization server computer 108 may determine, from the retrieved card data, whether the most recent previous top-up transaction was confirmed to have been properly completed. If the card data indicates that this was not the case, the top-up authorization server computer 108 may use data included in the top-up request to synchronize the card data (from database 318, FIG. 3) with pre-paid balance information contained in the top-up request. That is, the top-up authorization server computer 108 may determine from information contained in the top-up request whether the most recent previous top-up transaction was completed successfully, and then may resolve the cumulative upper limit for prepaid transactions for the mobile telephone in question to reflect such information as contained in the top-up request received from the mobile telephone 102.

Step 712 then follows step 710. At 712, the top-up authorization server computer 108 communicates with the issuer back-office server computer 106 to determine whether the top-up request should be authorized. In essence, the top-up authorization server computer 108 inquires of the issuer back-office server computer 106 whether the user's underlying payment card account (credit card account or debit card account) will support the requested top-up, and receives a response back from the issuer back-office server computer 106 to indicate whether or not this is the case. If the issuer back-office server computer 106 provides a positive response, then the issuer back-office server computer 106 charges the requested top-up to the user's account, and the process of FIG. 7, as performed in the top-up authorization server computer 108, advances to 714 from 712. (In a branch of the process which is not explicitly shown in the drawing, if the issuer back-office server computer 106 provides a negative response, then the top-up authorization server computer 108 sends a message back to the mobile telephone 102 to indicate that the top-up request is declined.)

At 714, the top-up authorization server computer 108 updates the card data (for database 318) to reflect authorization of the top-up request. The top-up authorization server computer 108 also calculates new balance information to implement the top-up request. For example, the top-up authorization server computer 108 may add the requested amount of the top-up to the previous upper cumulative transaction amount to produce a new upper cumulative transaction amount. This amount may be stored in the card data, and also may be used to generate the response that the top-up authorization server computer 108 is to send to the mobile telephone 102. For example, the top-up authorization server computer 108 may generate a script that is to be executed by the mobile telephone to increase the upper cumulative transaction amount stored in the mobile telephone. In addition, the top-up authorization server computer 108 may generate a cryptogram to be included in the response. This may be done, for example, in accordance with the provisions of the above-mentioned M/Chip Select 4 standard. The top-up authorization server computer 108 may then send a response, including the script and the cryptogram, to the mobile telephone 102 as the response to the top-up request.

Following 714, the process of FIG. 7 advances to 716. At 716, the top-up authorization server computer 108 waits for a confirmation message from the mobile telephone (to confirm that the top-up transaction was successfully completed in the mobile telephone 102) or for a timeout period to elapse. At decision block 718, the top-up authorization server computer 108 determines which of these two conditions takes place. If, at 718, the top-up authorization server computer 108 determines that it has received a confirmation message from the mobile telephone 102, then the process advances from decision block 718 to block 720.

At 720, the top-up authorization server computer 108 performs validity checks with respect to the confirmation message received from the mobile telephone 102. For example, the top-up authorization server computer 108 may check that a transaction counter in the confirmation message has an expected value, and that a cryptogram included in the confirmation message is valid. The top-up authorization server computer 108 may also check the correctness of balance information (e.g., an upper cumulative transaction amount) included in the confirmation message.

Step 722 follows step 720. At 722 the top-up authorization server computer 108 updates the card data (status data) to reflect the confirmation that the top-up transaction was successfully completed at the mobile telephone 102. This may involve, for example, resolving the balance information to reflect successful completion of the top-up transaction. One or more status flags may also be set to appropriate values. In addition, as indicated at 724, the top-up authorization server computer 108 may set the appropriate flag to indicate that the just authorized top-up was “confirmed”. The top-up authorization server computer 108 may next, as indicated at 726, generate a clearing record (including the “confirmed” flag), and then close the OTA messaging connection, as indicated at 728. (Although not so indicated in the drawing, the process may then loop back from 728 to 702, to await another incoming connection.)

Considering again decision block 718, if it is the case that the timeout period expires prior to receipt of a confirmation message, then the process branches from 718 to 730. At 730, the top-up authorization server computer 108 sets a flag to indicate an “unconfirmed” status for the request top-up transaction. The process then advances from 730 to 726, at which the top-up authorization server computer 108 generates a clearing record including the “unconfirmed” flag that indicates the ambiguous status of the just authorized top-up. The “unconfirmed” flag serves as an indication that the ambiguity needs to be resolved upon receipt of the next top-up request from the mobile telephone in question. The process of FIG. 7 then advances from 726 to 728, as described above.

FIG. 8 is a flow chart that illustrates a process that may be performed in the mobile telephone of FIG. 4 in accordance with aspects of the present invention.

At 802 in FIG. 8, the mobile telephone 102 (e.g., via the midlet 606, FIG. 6) determines whether the user has indicated that he/she wishes to request a top-up for the mobile telephone's prepaid payment capability. For example, the midlet may receive an indication to this effect as a result of the user providing input to the mobile telephone by selecting an item in a menu presented by the user interface 608 (FIG. 6) provided by the mobile telephone 102. Such a menu, for example, may be presented by a “wallet” function that the user has accessed in the mobile telephone 102.

As indicated by branch 804 from 802, the process of FIG. 8 may idle at 802 until the user indicates that a top-up should be requested. However, once the mobile telephone 102 receives such an indication, then the process of FIG. 8 advances from 802 to 806.

At 806, the mobile telephone (e.g., via midlet 606) opens an OTA messaging connection (e.g., a GPRS connection) with the top-up authorization server computer 108. In connection with this step, for example, the midlet 606 may retrieve the “http” address of the top-up authorization server computer 108.

Then, at 808, the mobile telephone (e.g., via midlet 606 and user interface 608) prompts the user to enter a monetary amount by which the prepaid balance is to be topped-up. This may be done, for example, by displaying one or more messages on the display 410 (FIG. 4) of the mobile telephone. For example, the user may be prompted to select a menu item, and/or to enter numerical data via the keypad 412 or by operating another input device included in the mobile telephone.

In some embodiments, step 806 may also include the midlet 606 querying the payment application 604 (FIG. 6) as to the current balance available in the mobile telephone for prepaid transactions. The midlet 606 may then direct the user interface 608 to present this information to the user, while also asking the user to select/input a monetary amount for the top-up request.

Step 810 follows step 808. At step 810, the mobile telephone receives, from the user, input to designate the monetary amount for the top-up request. This may occur via the user interacting with the user interface, which passes the user's input to the midlet.

Step 810 is followed by step 812. At step 812 the mobile telephone prompts the user to enter his/her passcode. This may occur via the midlet and the user interface, and is a security measure to reduce the possibility of unauthorized use of the mobile telephone for payment purposes. More specifically, the user may enter the passcode by operating the keypad 412 or another input device included in the mobile telephone. At step 814, the mobile telephone receives the user's input of the passcode, and at 816 the mobile telephone verifies the correctness of the passcode entered by the user. Both of these steps may entail cooperation among the payment application, the midlet, and the user interface.

In some embodiments, the payment application may limit the number of times the user may attempt to enter the passcode correctly. For example, the payment application may store a “passcode try counter” (PTC), which may be initially set at “3” and which may be decremented with each incorrect attempt to enter the passcode. If the PTC is at “0”, then the midlet may abort the user's attempt to request topping-up. The payment application, the midlet, and the user interface may cooperate in permitting, tracking and limiting the number of times the user is allowed to attempt entry of the passcode.

Although the above steps 806-816 have been presented in the drawing and discussed above in a certain order, it should be understood that this order may be varied. For example, in some embodiments, the connection to the top-up authorization server computer 108 may be opened only after the monetary amount for the top-up has been entered and the passcode has been entered and verified. Similarly, in some embodiments, the passcode may be entered and verified before the monetary amount for the top-up is entered.

Following steps 806-816 is step 818. At 818, the mobile telephone 102 sends an OTA message to the top-up authorization server computer 108 to request the top-up desired by the user. This message may, for example, include a cryptogram that the mobile telephone/payment application calculated before sending the message. The cryptogram may be passed from the payment application to the midlet for inclusion in the top-up request. The message as constructed by the midlet may also include the monetary amount for the top-up as specified by the user.

Decision block 820 follows step 818. At 820, the mobile telephone determines whether it has received an OTA response to the top-up request from the top-up authorization server computer 108. As indicated by branch 822 from decision block 820, the process of FIG. 8 may idle until the response from the top-up authorization server computer 108 is received. (In some embodiments, the process of FIG. 8 may time out and abort if the response is not received within a predetermined period of time after the top-up request is sent.)

When the OTA response from the top-up authorization server computer 108 is received, the process of FIG. 8 advances from decision block 820 to block 824. (The ensuing description assumes that the response from the top-up authorization server computer 108 indicates that the top-up was authorized. If such is not the case, then the process of FIG. 8 may abort upon receiving the response from the top-up authorization server computer 108.) At 824, the midlet parses the response and passes the script contained in the response to the payment application. The payment application executes the script, thereby effecting an increase in the prepaid balance stored in the mobile telephone. For example, execution of the script may increase the upper cumulative transaction amount stored in the payment application.

The process of FIG. 8 advances from 824 to 826. At 826, the midlet requests the upper cumulative transaction amount from the payment application to confirm that the top-up was successfully completed by the payment application. The midlet also requests a script counter from the payment application. The script counter is for indicating to the top-up authorization server computer 108 that the script sent in the response was executed by the payment application. Still further, the midlet may request the payment application to generate a cryptogram. The midlet then handles transmission of the confirmation message (as an OTA message) to the top-up authorization server computer 108. The confirmation message may include the script counter and the cryptogram passed from the payment application to the midlet. After sending the confirmation message, the midlet may close the OTA connection to the top-up authorization server computer 108, as indicated at 828 in FIG. 8.

In some embodiments, the mobile telephone 102 and the top-up authorization server computer 108 may engage in OTA communication for purposes other than authorizing a top-up request. For example, the mobile telephone may communicate OTA with the top-up authorization server computer 108 for the purpose of requesting a reset of the passcode try counter (PTC). From the point of view of the mobile telephone, this process may be initiated in response to user input, and may entail the midlet opening an OTA connection with the top-up authorization server computer 108. The midlet may request that the payment application generate a cryptogram, and may include the cryptogram in the PTC reset request message that the midlet sends OTA to the top-up authorization server computer 108. In some embodiments, the PTC reset request message may also include the current upper cumulative transaction amount so that, if necessary, the top-up authorization server computer 108 may confirm that the latest top-up transaction was completed successfully in the mobile telephone. After sending the PTC reset request message, the midlet may wait for a response from the top-up authorization server computer 108.

Typically, the user may initiate the PTC reset request after making contact by voice telephone conversation with a customer service representative of the issuer. The user may, for example, tell the customer service representative that he/she needs a PTC reset, and may authenticate his/her identity by correctly answering one or more security questions posed to him/her by the customer service representative. The customer service representative would then provide input to the issuer back-office server computer 106 to indicate that a PTC reset is permitted. The issuer back-office server computer 106, in turn, may transmit a message to the top-up authorization server computer 108 to indicate that a PTC reset is permitted. In response to that message, the top-up authorization server computer 108 may set an appropriate flag in the card data for the user.

From the point of view of the top-up authorization server computer 108, the PTC reset process itself begins with an incoming OTA connection from the mobile telephone in question. The top-up authorization server computer 108 receives the PTC reset request received OTA from the mobile telephone, retrieves the card data for the mobile telephone, checks whether the PTC reset flag has been set, and performs checks on the request (e.g., checks a transaction counter and a cryptogram included in the request). If necessary, the top-up authorization server computer 108 also resolves available balance information, as contained in the request, to confirm that the most recent top-up was completed successfully.

If the request message checks out and the PTC reset flag in the retrieved card data is set, then the top-up authorization server computer 108 generates and sends a suitable response to the mobile telephone. The response is sent as an OTA message and may include a script to be executed in the mobile telephone to effect a reset of the PTC.

When the mobile telephone receives the response from the top-up authorization server computer 108, the midlet parses the response and passes the script to the payment application. The payment application executes the script, thereby causing a reset of the PTC. The midlet then closes the OTA connection with the top-up authorization server computer 108.

Although the top-up authorization server computer 108 is portrayed in the above description as a single computer, it may in practice be constituted by two or more computers. For example, the top-up authorization server computer 108 may be constituted by two computers, in cooperation and communication with each other, of which one primarily handles OTA communication with mobile telephones, and the other primarily handles communication with the issuer back-office server computer 106 and authorization of top-up transactions. In addition, there may be a further computing device—associated with the top-up authorization server computer(s)—which primarily handles management of encryption keys.

Similarly, the issuer back-office server computer 106 may be constituted by two or more intercommunicating and cooperative computers. For example, the main back office computer may have additional computers associated therewith to handle (a) card management, (b) card issuance, and (c) key management.

Reference was made in the above discussion to communication between the mobile telephone and the POS terminal in a manner consistent with the EMV standard or in accordance with the well-known PayPass standard utilized in the U.S. Other types of communication are also possible, however, including communication via NFC. Other types of pre-paid transaction systems could be employed in alternative embodiments of the invention.

The payment application in the mobile telephone may maintain a log of all offline purchase transactions and top-up transactions performed by the mobile telephone. This log may be accessible to the user via the user interface and the midlet.

Although the previous discussion has indicated that the payment application may be implemented in accordance with the M/Chip 4 Select standard, this is only one example of possible implementations of the payment application. In alternative embodiments of the invention, other types of payment applications may be employed.

In addition to the above-described functionality for offline purchase transactions, the mobile telephone may in some embodiments also include functionality for engaging in online payment card system transactions, in substantially the same manner as a contactless credit or debit card.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, the term “OTA” or “over-the-air” should be understood to refer to an exchange of data messages via at least one mobile telephone network, and more specifically calls for transmission of data (in either or both directions) between a mobile telephone and a cellular communications base station.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, a debit card, a prepaid card and/or a pre-authorized card.

As used herein and in the appended claims, the term “prepaid” includes “pre-authorized”. Accordingly, a prepaid payment capability may or may not imply linkage to an underlying account.

As used herein and in the appended claims, the term “payment card system” refers to a system for handling purchase transactions and related transactions and operated under the name of MasterCard, Visa, American Express, Diners Club, Discover Card or a similar system. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a processor of a mobile telephone, a selection by a user of a top-up request for an offline balance in an offline payment application of the mobile telephone;
opening, by the processor, an over-the-air (OTA) connection to a top-up authorization server computer;
prompting, by the processor, the user to enter a monetary amount for the top-up request for the offline balance and to enter a form of authentication;
receiving a monetary amount input and a user authentication input;
authenticating the user;
calculating, by the processor, a cryptogram;
transmitting, by the processor, an OTA top-up request message to the top-up authorization server computer comprising the monetary amount and the cryptogram;
receiving, by the processor, an OTA response from the top-up authorization server computer indicating authorization of the top-up request and including a script; and
executing, by the processor, the script to increase the offline balance stored in the mobile telephone by the monetary amount.

2. The method of claim 1, further comprising transmitting, by the processor, an OTA confirmation message to the top-up authorization server computer.

3. The method of claim 2, wherein transmitting the OTA confirmation message to the top-up authorization server computer comprises:
determining, by the processor, a script counter indicative of execution of the script received from the top-up authorization server computer; and
transmitting the script counter to the top-up authorization server computer.

4. The method of claim 2, further comprising closing, by the processor, the OTA connection to the top-up authorization server computer.

5. The method of claim 1, further comprising, prior to prompting the user to enter a monetary amount for the top-up request, displaying a current balance of the offline balance to the user.

6. The method of claim 1, wherein prompting the user to enter a monetary amount for the top-up request comprises one of prompting the user to select a menu item, prompting the user to enter a numerical amount via a keypad, or prompting the user to select a numerical amount.

7. The method of claim 1, wherein the user authentication input is a passcode, and further comprising, subsequent to receiving the passcode:
determining, by the processor, that the passcode is incorrect;
determining, by the processor, that a passcode try counter value is greater than zero;
decrementing the passcode try counter; and
prompting, by the processor, the user to retry entry of the passcode.

8. The method of claim 7, further comprising, subsequent to determining that the passcode is incorrect:
determining, by the processor, that the passcode try counter value is zero; and
closing, by the processor, the OTA connection to the top-up authorization server computer to abort the user OTA top-up request.

9. The method of claim 1, further comprising, subsequent to transmitting an OTA top-up request message to the top-up authorization server computer:
determining, by the processor, that an OTA response from the top-up authorization server computer indicating authorization of the top-up request has not been received within a predetermined amount of time; and
closing, by the processor, the OTA connection to the top-up authorization server computer to abort the user OTA top-up request.

10. The method of claim 1, wherein increasing the offline balance stored in the mobile telephone comprises increasing an upper cumulative limit.

11. A mobile telephone comprising:
a processor;
at least one input device operably connected to the processor;
at least one output device operably connected to the processor;
receive/transmit circuitry operably connected to the processor;
a proximity payment controller operably connected to the processor; and
a memory operably connected to the processor and storing an offline payment application, the offline payment application comprising instructions configured to cause the processor to:
receive, via the at least one input device, a top-up request from a user for an offline balance in an offline payment application of the mobile telephone;
open an over-the-air (OTA) connection to a top-up authorization server computer;
prompt the user to enter a monetary amount for the top-up request for the offline balance and to enter a form of authentication;
receive a monetary amount input and a user authentication input;
authenticate the user;
calculate a cryptogram;
transmit, via the receive/transmit circuitry, an OTA top-up request message to the top-up authorization server computer comprising the monetary amount and the cryptogram;
receive, via the receive/transmit circuitry, an OTA response from the top-up authorization server computer indicating authorization of the top-up request and including a script; and
execute the script to increase the offline balance stored in the mobile telephone by the monetary amount.

12. A non-transitory computer readable medium storing instructions configured to cause a mobile device processor to:
receive a selection of a top-up request for an offline balance in an offline payment application of the mobile telephone;
open an over-the-air (OTA) connection to a top-up authorization server computer;
prompt the user to enter a monetary amount for the top-up request for the offline balance and to enter a form of authentication;
receive a monetary amount input and a user authentication input;
authenticate the user;
calculate a cryptogram;
transmit an OTA top-up request message to the top-up authorization server computer comprising the monetary amount and the cryptogram;
receive an OTA response from the top-up authorization server computer indicating authorization of the top-up request and including a script; and
execute the script to increase the offline balance stored in the mobile telephone by the monetary amount.

13. The non-transitory computer readable medium of claim 12, further comprising instructions configured to cause the processor to transmit an OTA confirmation message to the top-up authorization server computer.

14. The non-transitory computer readable medium of claim 13, wherein the instructions for transmitting the OTA confirmation message comprises instructions configured to cause the processor to:
determine a script counter indicative of execution of the script received from the top-up authorization server computer; and
transmit the script counter to the top-up authorization server computer.

15. The non-transitory computer readable medium of claim 12, further comprising instructions configured to cause the processor to close the OTA connection to the top-up authorization server computer.

16. The non-transitory computer readable medium of claim 12, further comprising, prior to the instructions for prompting the user to enter a monetary amount for the top-up request, instructions configured to cause the processor to display a current balance of the offline balance to the user.

17. The non-transitory computer readable medium of claim 12, wherein the instructions for prompting the user to enter a monetary amount for the top-up request comprises instructions configured to cause the processor to at least one of prompt the user to select a menu item, prompt the user to enter a numerical amount via a keypad, or prompt the user to select a numerical amount.

18. The non-transitory computer readable medium of claim 12, wherein the user authentication input is a passcode, and further comprising, subsequent to receiving the passcode, instructions configured to cause the processor to:
determine that the passcode is incorrect;
determine that a passcode try counter value is greater than zero;
decrement the passcode try counter; and
prompt the user to retry entry of the passcode.

19. The non-transitory computer readable medium of claim 18, further comprising, subsequent to determining that the passcode is incorrect, instructions configured to cause the processor to:
determine that the passcode try counter value is zero; and
close the OTA connection to the top-up authorization server computer to abort the user OTA top-up request.

20. The non-transitory computer readable medium of claim 12, further comprising, subsequent to the instructions for transmitting an OTA top-up request message to the top-up authorization server computer, instructions configured to cause the processor to:
determine that an OTA response from the top-up authorization server computer indicating authorization of the top-up request has not been received within a predetermined amount of time; and
close the OTA connection to the top-up authorization server computer to abort the user OTA top-up request.

21. The non-transitory computer readable medium of claim 12, wherein the instructions for increasing the offline balance stored in the mobile telephone comprises instructions configured to cause the processor to increase an upper cumulative limit.
